(19) United States
(12) Patent Application Publication
(10) Pub. No.: US 2023/0385765 A1
(43) Pub. Date: Nov. 30, 2023

(54) SYSTEM AND METHOD FOR CLASSIFICATION OF SPEND DATA

(71) Applicant: Zycus Infotech Pvt Ltd, Mumbai (IN)

(72) Inventor: Sanjay Kumar Singh, Mumbai (IN)

(73) Assignee: Zycus Infotech Pvt Ltd, Mumbai (IN)

(21) Appl. No.: 18/117,424

(22) Filed: Mar. 4, 2023

(30) Foreign Application Priority Data
Mar. 24, 2022 (IN) 202221016596

(51) Int. Cl. G06Q 10/0875

(52) U.S. Cl. CPC G06Q 10/0875

(57) ABSTRACT

A system and method for classification of spend data wherein the system comprises a user computer system, a processing unit, a communication interface, a first input receiving component, a second input receiving component, and a spend classification module further comprising a sentence tokenizer, a word tokenizer, a co-reference tagger, at least one language dictionary, and at least one standard taxonomy and/or custom taxonomy, a keyword sense tagger, and a sense scorer, such that the sense scorer further includes a category normalizer matrix, a category summarizer matrix and a heuristic learning matrix; and wherein the method comprises the steps of receiving a dataset of spend data from the user, transmitting the dataset to the spend data classification module, processing of the dataset by the spend data classification module, receiving a query term from the user, mapping the query term, and displaying the data so processed to the user.

### CROSS-REFERENCE TO RELATED APPLICATION

The instant application claims priority to Indian Patent Application Serial No. 202221016596, filed Mar. 24, 2022, pending, the entire specification of which is expressly incorporated herein by reference.

### FIELD OF THE INVENTION

The present invention relates broadly to the field of information and computation systems and methods with respect to procurement spend data management. More particularly, the present invention relates to a system and method for classification of spend data for efficient spend analysis.

### BACKGROUND OF THE INVENTION

Procurement is an integral part of e-commerce. Efficient procurement is key to the success of any commercial business. Procurement spend data needs to be effectively managed to achieve improved operational and financial efficiency. Spend management is an important step in the procurement cycle. Spend management refers to a process of collecting, collating, maintaining, categorizing, and evaluating spend data to reduce procurement costs, improve efficiency, monitor and control workflows, and regulate compliance.

In the spend management cycle, spend data refers to the data relating to the company's expenditure on goods and services purchased from external suppliers. This spend data needs to be collected, collated, maintained, classified into appropriate categories, and analyzed to achieve improved operational and financial efficiency. Spend data classification plays and important role in the spend management cycle.

Spend data is usually classified into appropriate product and/or service categories to enable better visibility of spend data, thereby allowing better spend analysis. Spend data classification involves logical grouping of similar products and/or services in distinct categories or buckets. The classification of spend data into appropriate categories involves use of a taxonomy or categorization tree. The taxonomy or categorization tree allows hierarchical classification of the spend data into appropriate categories of goods and/or services. Conventionally, a widely used taxonomy of products and services is the United. Nations Standard Products and Services Code (UNSPSC) taxonomy. It is a four level hierarchy wherein the four levels are Segment, Family, Class, and Commodity. A major source of error in spend data classification comes from the involvement of manual intervention for labeling the data. Classification of spend data is subjective in nature and very much depends on the context.

There are a few spend data classification solutions present in the market currently. However, the existing solutions have certain limitations. Firstly, these solutions are designed to work on global meaning, context, and synonyms. These solutions fail to recognize and appreciate local context of words, necessary for discovering relationship between two independent concepts. For example, at times, it becomes tricky for a system to recognize if the word (product) “tablet” would belong to the pharmaceuticals category (e.g., PARACETAMOL tablet) or to the electronics category (e.g., SAMSUNG tablet). This leads to ambiguity in word sense, with little or no contextual background.

Secondly, the existing solutions are at times based on semantic, dictionary-based rules. The inclusion of semantic rules necessitates involvement of a domain expert to label the spend data or create specific rules. The manual work involved in labeling the spend data is paramount. Equally or more taxing is the creation of semantic dictionary based rules. Both these things lead to over-reliance on manually supervised techniques. Furthermore, the memory and computation hardware requirement for semantic rules is very high. This, in turn, makes the entire spend data classification process cost and infrastructure intensive. In addition to this, high maintenance is required for such systems due to continuous labeling of new data or new rules development for different non-trained variations.

The following example may be considered for clarity purposes. Every word used to describe a particular category can be homonymous or polysemous local to its context in a document. For instance, the word “chairs” can be used to define its entity type as a “person” or “furniture” based on usage with its neighboring local phrases. Similarly, a phrase like “cleaning supplies” may be associated with the segment “chemicals including bio chemicals and gas materials” or “office equipment and accessories and supplies”. This word sense and word context ambiguity complicates the classification process. The existing solutions fail to take the local context of words into consideration, across the available spend data (which is typically in the form of documents). When one chooses to apply a uniform classification (e.g., UNSPSC), or clustering techniques based on global context, it leads to loss of local information resulting in wrong mapping of the spend data. This in turn may result into incorrect classification of goods and services.

Thirdly, only on the basis of the available taxonomy and sample dataset (the available spend data documents), it is difficult to achieve a great level of accuracy in terms of spend data classification. All the drawbacks stated above consequentially hamper the accuracy of the spend data classification process.

### PRIOR ART

U.S. Patent Publication No. 20180032602 discloses a system for performing data classification operations. In one embodiment, the system comprises a file system configured to store a plurality of computer files and a scanning agent configured to traverse the file system and compile data regarding the attributes and content of the plurality of computer files. The system also comprises an index configured to store the data regarding attributes and content of the plurality of computer files and a file classifier configured to analyze the data regarding the attributes and content of the plurality of computer files and to classify the plurality of computer files into one or more categories based on the data regarding the attributes and content of the plurality of computer files. Results of the file classification operations can be used to set appropriate security permissions on files which include sensitive information or to control the way that a file is backed up or the schedule according to Which it is archived. However, the system and method is aimed at classifying computer files and not spend data per se.

Hence, there is a need for an improved solution for spend data classification which is able to overcome the above stated drawbacks of the existing solutions.

### OBJECTS OF THE INVENTION

An object of the present invention is to provide a system and method for classification of spend data.

Another object of the present invention is to provide a system and method for classification of spend data, which has improved accuracy and minimized word sense ambiguity over existing solutions.

Yet another object of the present invention is to provide a system and method for classification of spend data, which takes the local context of keywords into consideration.

Yet another object of the present invention is to provide a system and method for classification of spend data, which does not involve manual labeling of spend data, and does not necessitate the involvement of a domain expert for the same.

Yet another object of the present invention is to provide a system and method for classification of spend data, which is less cost intensive.

Yet another object of the present invention is to provide a system and method for classification of spend data, which has less memory, computation and hardware requirements.

Yet another object of the present invention is to provide a system and method for classification of spend data, which requires low maintenance.

Yet another object of the present invention is to provide a system and method for classification of spend data, which works on the principle of heuristic learning that uses dataset of spend data and provides specifications to develop intelligence and classify the spend data with very limited information provided.

Yet another object of the present invention is to provide a system and method for classification of spend data, which correctly identifies the relationship between two autonomously developed conceptual representations e.g., user defined category (custom taxonomy) and the UNSPSC categories (standard taxonomy).

Yet another object of the present invention is to provide a system and method for classification of spend data, which actively learns and adjusts to the available information and performs categorization of spend data based on the available and actively learned knowledge.

Yet another object of the present invention is to provide a system and method for classification of spend data, which does not require a manual supervision throughout the classification process.

### SUMMARY OF THE INVENTION

The present invention relates to a system and method for classification of spend data. In one aspect the system of the present invention comprises of a user computer system, a processing unit operably associated with the user computer system, a communication interface for accessing the user computer system from a plurality of input and/or output devices, a first input receiving component configured to receive input in the form of dataset of spend data provided by the user, a second input receiving component configured to receive input in the form of query term provided by the user, and a spend data classification module adapted to process the dataset and the query term resulting into classification of the spend data.

In yet another aspect, the method for classification of spend data comprises the steps of receiving a dataset of spend data to be classified from a user, transmitting the dataset of spend data to a spend data classification module, processing of the received dataset of spend data by the data classification module, receiving a keyword based query term from the user, mapping the query term to the sparse matrix generated by the sense scorer for classification into appropriate product and/or service categories, and displaying the data processed by the spend data classification module to the user.

In yet another aspect, the processing of spend data by the spend data classification module comprises the steps of processing individual documents in the dataset of in a sequential manner by a sentence tokenizer, a co-reference tagger, a word tokenizer, a language dictionary and a standard and/or custom taxonomy, a keyword sense tagger, and a sense scorer.

In yet another aspect, the system of the present invention is such that it takes local context of the words in the spend data into consideration, has improved accuracy in terms of classification and has minimized sense ambiguity. The system has less memory, computation and hardware requirements. The system of the present invention is further configured to take bidirectional context into consideration.

In yet another aspect, the system of the present invention works on the principle of heuristic learning to actively learn and adjust on the basis of available spend data, develop intelligence and classify spend data with very limited information provided. In yet another aspect, the system of the present invention does not require manual supervision throughout the classification process. The system is easily adaptable to and can be scaled into multiple languages seamlessly without requiring any supervised training. In yet another aspect, the system and method of the present invention is such that the sense and hierarchical scoring is based on probabilistic and custom developed statistical values.

### BRIEF DESCRIPTION OF THE DRAWINGS

The present invention, together with further objects and advantages thereof, is more particularly described in conjunction with the accompanying drawings in which:

FIG. 1 illustrates the components and overall workflow of the system and method of the present invention;

FIG. 2 illustrates a language dictionary and/or WordNet represented as a Directed Acyclic Graph;

FIG. 3 illustrates a joint-probability distribution symmetric matrix for n-gram words;

FIG. 4 illustrates a sparse matrix generated by the sense scorer;

FIG. 5 illustrates an expanding sparse matrix based on heuristic or active learning;

FIG. 6 illustrates the hierarchical classification of the spend data; and

FIG. 7 illustrates an implementation of category normalization.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

Definitions set forth in the Table below:

TABLE

| Term | Definition |
|---|---|
| Affinity | Affinity score refers to a statistical term used to indicate |
| Score | the degree of association between two entities. |
| Affinity | Association between two entities. |
| Unigram | In context of text analytics, character size = 1 refers to Unigram |
| | Chars of size = 2 are referred as bigram, chars of size = 3 are referred as |
| | trigram, chars of size = n are referred as n-gram. |
| Bigram | In context of text analytics, character size = 2 refers to Bigram |
| Trigram | In context of text analytics, character size = 3 refers to Trigram |
| N-gram | In context of text analytics, character size = n refers to n-gram |
| Probability | Probability in numerical sense refers to likelihood of an event to occur |
| Joint | Given two random variables that are defined on the same probability |
| probability | space, the joint probability distribution refers to the corresponding |
| | probability distribution on all possible pairs of outputs. |
| Bidirectional | Bidirectional context refers to context of system which can be trained on |
| context | sequence of words in both directions (left to right and right to left). |
| Node | Nodes refer to the vertices in a graph. |
| Root | Parent node refers to as root. |
| Parent | First node in a graph is defined as parent |
| Child | Second node onwards in a graph are referred to as child |
| Boost | Boost value refers to a value that can function in a system to influence |
| value | ranking of the subsequent entity |
| Reward and | Reward and penalty refer to course correction behaviour of a system |
| penalty | through feedback and backward propagation technique |
| Joint | Joint entropy refers to the measure of uncertainty associated |
| entropy | with a set of variables |
| Information | Information gain refers to the reduction in entropy or surprise by |
| gain | transforming a dataset and is often used in training decision trees. |
| | Information gain is calculated by comparing the entropy of the dataset |
| | before and after a transformation. |
| Expectation | The expectation-maximization algorithm refers to an approach for |
| maximization | performing maximum likelihood estimation in the presence of latent |
| algorithm | variables. It does this by first estimating the values for the latent |
| | variables, then optimizing the model, then repeating these two steps until |
| | convergence. |
| Dataset | Collection of spend data documents |

The present invention relates to a system and method for classification of spend data. The system of the present invention comprises of a user computer system, a processing unit operably associated with the user computer system, a communication interface for accessing the user computer system from a plurality of input and/or output devices, a first input receiving component configured to receive input in the form of dataset of spend data provided by the user, a second input receiving component configured to receive input in the form of a query term provided by the user, and a spend data classification module adapted to process the dataset and the query term resulting into classification of the spend data.

The spend data to be classified is primarily available in the form of transactional data of a particular business such as placement orders, invoices etc. This kind of spend data is typically in the form of multiple documents comprising of multiple paragraphs and sentences. The spend data may consist of a large amount of text including product and/or service items. The spend data may include a dataset comprising of multiple such documents. In the present invention, the user is enabled to provide a keyword based query term which is then mapped to the dataset of spend data, to ultimately classify the spend data. It is to be noted that in different embodiments of the present invention, the query term may be a single word or a multi word query term. For the ease of understanding, the invention shall be, wherever needed, described by means of suitable examples meant solely for explanatory purposes. These examples should not be considered to limit the invention's implementation or functioning in any possible manner.

Considering an exemplary single keyword based query term for an exemplary product—“tablet”, the query term “tablet” can be considered as a “pharmaceutical item” or an “electronic item” in terms of product categories. As mentioned in the limitations of prior arts, this creates ambiguity in terms of sense or meaning of the query term and may lead to inaccurate classification of the spend data. For example, if the user is working in the pharmaceutical industry and wants to classify the spend data of his business, it shall be logical to assume that wherever the term “tablet” appears in the spend data of his business, it has a high likelihood to refer to a pill used in pharmaceutical industry (pharmaceutical item) and not a handheld electronic device used in the field of electronics (electronic item). However, since the prior arts function only on the basis of global context of words and fail to take the local context of the query term into consideration, “tablet” can be inaccurately classified as an electronic product. This would give a wrong visibility to the user. For instance, if the user in the above scenario is to analyse his classified spend data, and if he has actually spent 70% of total expenditures on procuring pills, the prior arts would wrongly give an impression that he has spent 70% of total expenditures on procuring electronic items. An incorrect spend data visibility is detrimental when operational and financial efficiency of a business is to be maximized.

The system and method of the present invention overcomes this problem of word sense ambiguity as it takes into consideration the local context of the individual keywords. The system and method is configured to intake a user defined custom taxonomy into consideration. The custom taxonomy component of the system provides the user an option to add preferences of categories or custom categories. The system is also configured to take the bidirectional context (i.e. right to left and left to right) into consideration. The working of this component as well as other components of the system of the present invention is described below in detail.

In a preferred embodiment, the system of the present invention comprises of a user computer system. The user is enabled to access the user computer system by means of a communication interface associated with the user computer system, from a plurality of input and/or output devices. The system further comprises of a first input receiving component configured to receive input in the form of a dataset of spend data provided by the user. The system further comprises of a second input receiving component configured to receive input in the form of a query term provided by the user, for which probable product and/or service classes need to be identified. The system and method of the present invention maps the query term provided by the user to the dataset and involves multiple processing steps performed by the spend data classification module.

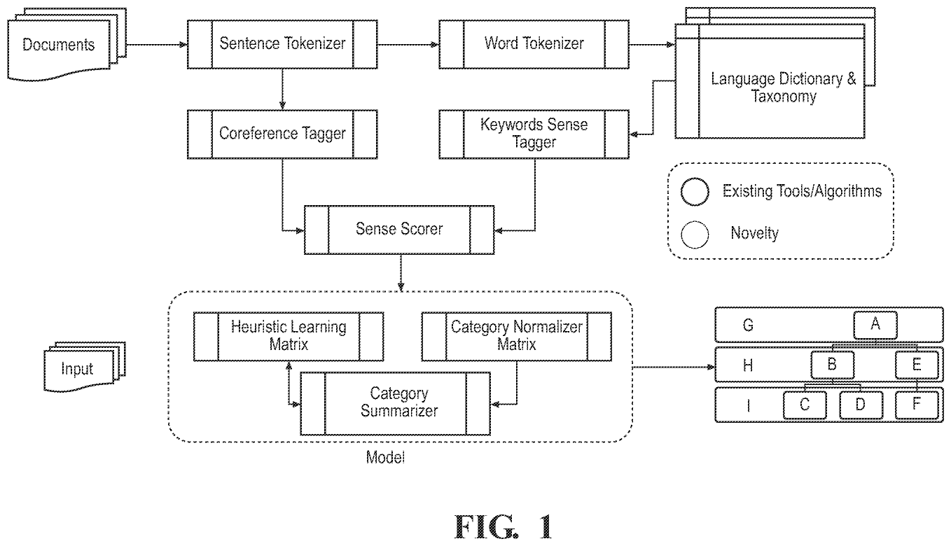

In a preferred embodiment, the spend data classification module of the system further comprises of multiple components such as a sentence tokenizer, a co-reference tagger, a word tokenizer, a language dictionary and taxonomy, a keyword sense tagger, and a sense scorer. The sense scorer further includes a category normalization matrix, category summarizer matrix and a heuristic learning matrix. These matrices work on the principles of linear algebra. The sense scorer further enables active learning, ranking and optimal categorization of spend data with respect to the product and/or service categories. The functioning of all the components of the spend data classification module as well as other components of the system are described below in reference to FIG. 1.

In an embodiment, the spend data is available in the form of a dataset comprising of multiple documents. These documents may be but are not limited to formats such as CSV files, tabular data, and databases. These documents contain extensive text. In a preferred embodiment, the first input receiving component of the system is configured to receive the dataset from the user. On receiving the dataset from the user, the system of the present invention transmits it to the spend data classification module. The dataset is then processed by different components of the spend data classification module. The dataset comprising of multiple documents is processed in a sequential manner such that one document is processed at a time, and then more and more documents are processed by the spend data classification module.

Firstly, the sentence tokenizer of the spend data classification module breaks down the text in the dataset into multiple individual sentences. At the same time, the sentence tokenizer also preserves the position of these individual sentences in the dataset. The individual sentences and their respective position information i.e. the sentence tokenizer processed data, is then passed simultaneously to the word tokenizer and the co-reference tagger.

The co-reference tagger performs the function of finding and tagging an association between individual sentences in terms of their meaning and context. For example, if a specific keyword appears in a particular context in sentence 3 and then appears in sentence 7 and 9 in a similar context, the co-reference tagger associates sentences 3, 7 and 9 with respect to that particular keyword. In this way, the co-reference tagger brings all the associated sentences together with respect to a particular keyword and its context in that sentence, and tags them. The data processed by the co-reference tagger is passed to the sense scorer.

As stated previously, in an embodiment, the sentence tokenizer processed information is passed to the word tokenizer and the co-reference tagger simultaneously. The functioning of the co-reference tagger has been described in the above explanation of the present invention. The functioning of the word tokenizer is described below.

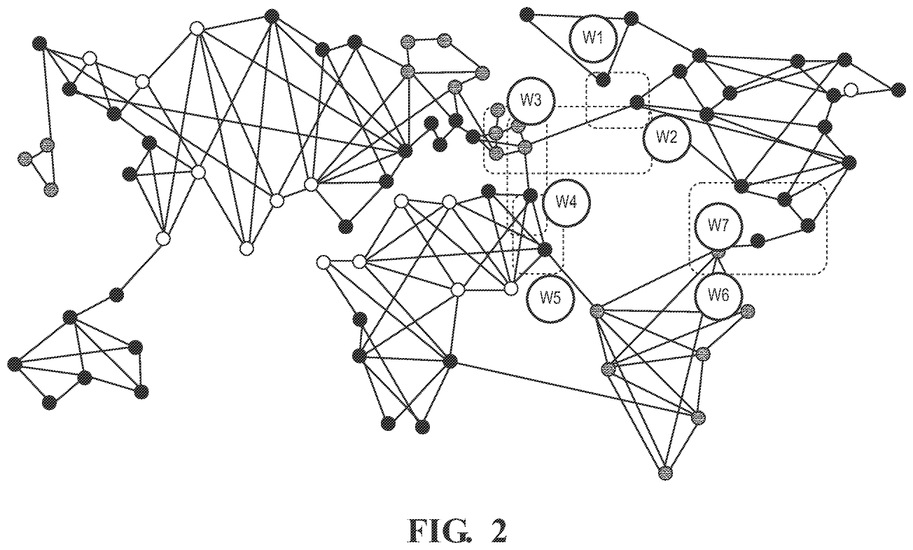

The word tokenizer primarily breaks down the individual sentences into individual keywords and tokenizes them. These individual keywords are then passed to and looked for in a language dictionary and a pre-defined standard taxonomy, and/or custom taxonomy provided by the user. The language dictionary is initially converted into a Directed Acyclic Graph (DAG). Each individual keyword obtained from the word tokenizer is represented as a node in the DAG (W1, W2, W3, W4, W5, . . . ). The DAG comprising of these nodes is as illustrated in FIG. 2. In an alternate embodiment, the system may comprise of more than one language dictionary and standard taxonomy, and/or custom taxonomy.

The DAG is traversed for the individual keywords and finds associated senses or meanings of those keywords unless the end of the vertex is reached. As shown in FIG. 2, the DAG also provides the interconnection (association), if any, between any two individual keywords. Each of these interconnections represent the association of two individual keywords with each other in terms of their sense, meaning or context. For example, relating to FIG. 2, W1 (keyword—“person”) and W2 (keyword—“furniture”) do not have a direct association with each other. Hence there is no direct line between nodes W1 and W2 (representing individual keywords) in the DAG of FIG. 2. However, the words W1 (keyword—“person”) and W2 (keyword—“furniture”) may be associated with each other through a common word “chair”. Hence, W1 and W2 may be represented close to each other enclosed within a dotted box as shown in FIG. 2. This indicates the association of keywords W1 and W2 with each other.

DAG of language dictionary helps in creating a foundation of a multi-dimensional sense sparse matrix. This is an important aspect of the present invention. In an embodiment of the invention, the language dictionary may be configured to be multilingual in nature. The language dictionary helps in identifying the meaning and synonyms of individual keywords. The individual keywords are also mapped to a standard and/or custom taxonomy. The data processed by the language dictionary and the taxonomy is passed to the keyword sense tagger.

Based on the data received from the language dictionary and a standard and/or custom taxonomy, the keyword sense tagger starts building sense for each individual keyword. The association between individual keywords is tagged by means of binary codes. Every pair of individual keywords having an association with each other in terms of their meaning, sense and local context, are assigned the binary value “1”. On the other hand, the pair of keywords having no association with each other are assigned the binary value “0”. The keyword sense tagger tags individual keywords in respect of the association and builds sense for individual keywords.

It is to be noted that more keywords, including synonyms get added to the initial number of individual keywords tokenized by the word tokenizer when the data is processed by the language dictionary and taxonomy. Hence, the total number of words to be processed by the sense scorer becomes “k”, wherein “k” includes the individual keywords tokenized by the word tokenizer as well as the ones added after processing by the language dictionary and taxonomy.

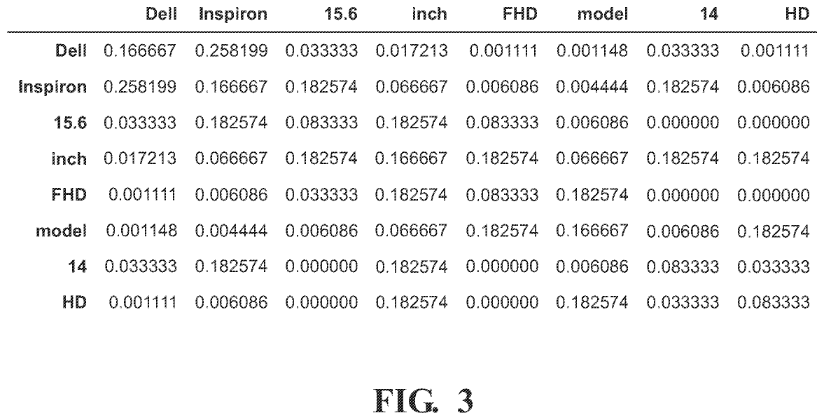

In an embodiment, once the data processed by the co-reference tagger and the keyword sense tagger is passed to the sense scorer, a joint probability based matrix is created to help compute the affinity score between individual keywords. A joint probability distribution symmetric matrix is illustrated in FIG. 3 based on exemplary keywords “DELL, INSPIRON, 15.6, inch, FHD, model, 14 and HD”. The values of this matrix represent the probabilistic values of each individual keyword with respect to every other individual keyword, and extend it in n-gram fashion to the level of desired configuration. The diagonal values in the matrix represent unigrams, while the rows or columns represent bigrams. The n-gram expansion is configurable to the level of n-grams e.g., unigram, bigram, trigram, . . . , n-gram, wherein “n” is the total number of individual keywords being processed. In FIG. 3, the probabilistic values are such that the sum of all individual probabilities is 1, i.e., Σᵢ₌₀ⁿ pᵢ=1.

The sense scorer takes into account the keyword pairing frequency as well as the distance between keywords to compute the affinity score between individual keywords. This helps in covering forward and backward feed. If the frequency of keyword pairing occurrences is more than 1, the mean distance between those individual keywords is multiplied by configurable boost value to yield the affinity score between the those individual keywords. The affinity score is computed based on the distance between individual keywords as well as the frequency of their occurrence together.

For example, the sense scorer will compute the distance between the keywords “PARACETEMOL” and “tablet” (Context 1) and also between the words “SAMSUNG” and “tablet” (Context 2). Here, Context 1 would correspond to a pharmaceutical item while Context 2 would correspond to an electronic item. The sense scorer will also compute how frequently the words “PARACETEMOL” and “tablet” appear together in the dataset (Context 1) versus how frequently the words “SAMSUNG” and “tablet” appear together in the dataset (Context 2). The combination of keyword distance and keyword frequency aspect is an unique feature of the present invention.

Considering the example of the query term “tablet” provided previously, it can be classified as a pharmaceutical item or an electronic item. The sense scorer starts building sense for the query term keyword(s) “tablet” by taking the local context into consideration. For instance, the keyword “tablet” may appear in association with other keywords such as “paracetamol” or “SAMSUNG”. When one says “PARACETEMOL tablet”, it is understood that the term “tablet” here refers to a pill. Likewise, when one says “SAMSUNG tablet”, it is understood that the term “tablet” here refers to a handheld electronic device. It is worth noting that this kind of sense computation is not present in the prior arts, and is unique to the present invention. The keyword sense computation takes into account the local context of the keywords, and is based on probability and joint probability between distributions instead of inferring meaning from global context. Here, the sense is built through keywords and their positions in the document.

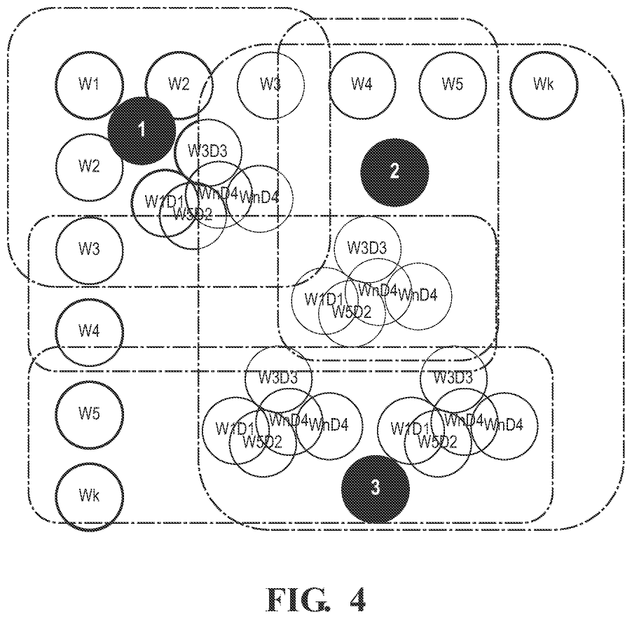

In an embodiment, based on the processed data received from the keyword sense tagger and the co-reference tagger, the sense scorer computes the affinity score between individual keywords as described above. The category normalization matrix component of the sense scorer generates a ‘k’×‘k’ sparse matrix as illustrated in FIG. 4. The sparse matrix is generated based on the affinity scores between individual keywords in the dataset. X and Y axis in FIG. 4 both represent individual keywords, such that;

X-axis data points are: W1, W2, W3, W4, . . . Wk.

Y-axis data points are: W1, W2, W3, W4, . . . Wk.

Wherein ‘k’ represents the total number of individual keywords initially mapped.

Each circle represents an individual keyword and the circles are placed on the matrix in such a manner that the distance between them represents the affinity between individual keywords. It is also apparent from the matrix that certain words have a sense overlap. The overlap of words is created based on reward and penalty considering factors like probability boosting by mean distance, joint entropy, information gain, odds ratio, and expectation-maximization algorithm.

On the basis of the sense overlap of these individual keywords, three clusters of keywords labeled as 1, 2, 3 can be seen being formed. Each cluster includes a group of keywords having a high affinity score with respect to each other. Each cluster represents a probable segment of products and/or services for classification. It is to be noted that this sparse matrix is an exemplary one meant for explanatory purposes. The nature of the matrix and the clusters being formed shall depend on the kind of spend data provided by the user.

In a preferred embodiment, the process of agglomerative clustering as described above is repeated a number of times as increasing number of documents in the spend dataset are analyzed. In this process, the cluster formation of keywords leads to origination of new words, at times bigrams and trigrams. The n-gram expansion is performed by the category summarizer matrix. This leads to a combination of new (n) and old keywords (k). Such combinations formed are added to the vocabulary of the system of the present invention by the heuristic learning matrix with the help of language dictionary.

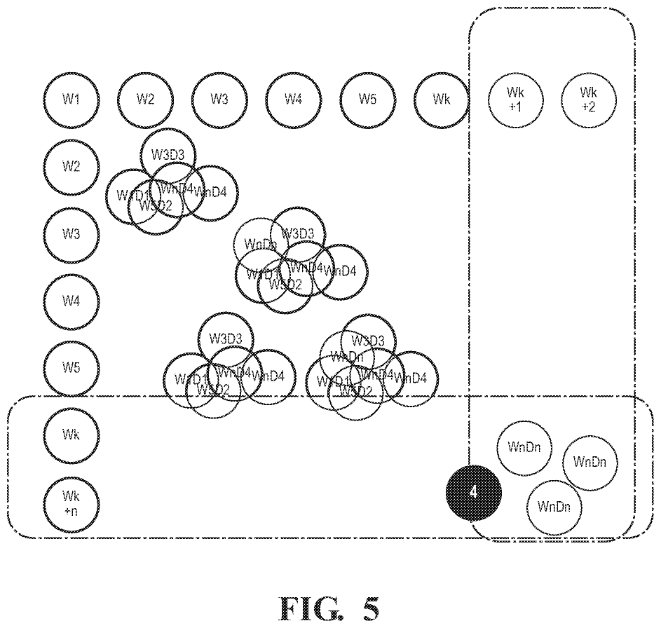

Referring to FIG. 5, which illustrates an expanding matrix, it can be seen that the sparse matrix originally represents a ‘k’×‘k’ dimension matrix similar to that of FIG. 4. For example, a matrix received by category normalization is originally such that;

X-axis data points are: W1, W2, W3, W4, . . . Wk.

Y-axis data points are: W1, W2, W3, W4, . . . Wk.

However, when increasing number of documents in the spend dataset are sequentially analyzed, new words such as “WnDn” are formed by the combination of other words in a particular cluster. In FIG. 5, it can be seen that the original matrix of ‘k’ dimensions now expands to ‘k+n’ dimensions wherein ‘n’ represents the number of new words added as a result of local context consideration, sense scoring, and hierarchical clustering by different components of the spend data classification module and active learning by the heuristic matrix of the sense scorer. Hence, the data points of the expanding matrix formed by heuristic learning are:

X-axis data points are: W1, W2, W3, W4, . . . Wk . . . Wk+n.

Y-axis data points are: W1, W2, W3, W4, . . . Wk . . . Wk+n.

As a result of this heuristic learning process, a new cluster 4 is formed, which comprises of multiple newly added words “WnDn”. As a result of the heuristic learning process, the heuristic learning matrix expands its dimensions in relation to the number of new words and their context added with analysis of each independent document in the spend data dataset. The alignment of new words is done based on language dictionary, local context and affinity scores. The heuristic learning process helps the system of the present invention to expand its awareness without re-training or manual intervention for newly added words. A key feature of the system of the present invention is that by means of heuristic learning, it actively learns by observing new patterns in relation to the keyword clusters. The newly added words as a result of the active learning are incorporated in the vocabulary of the system, before the analysis of next document, without any manual intervention.

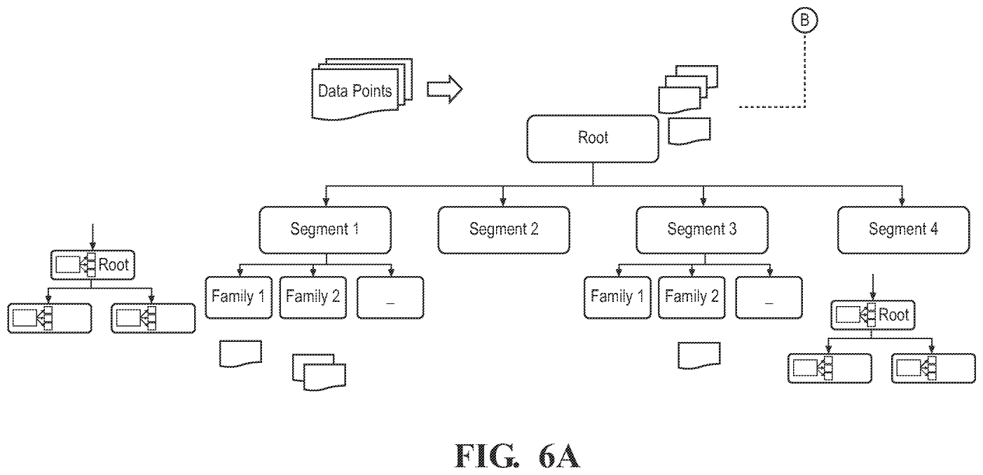

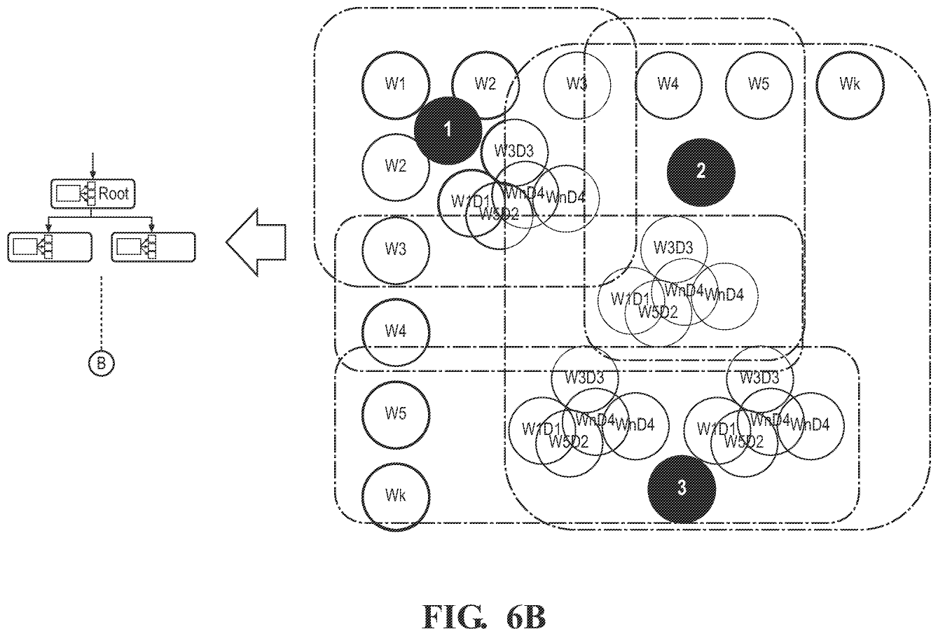

In an embodiment of the present invention, when all the documents in the dataset are analyzed and processed, a final sparse matrix of ‘k+n’ dimensions, including added vocabulary is generated. Once the user provides a query term, the query term is mapped to the final sparse matrix for identification of appropriate categories of product and/or services for the provided query term. Since the final sparse matrix is generated on the basis of the spend data provided by the user, local context is taken into consideration. The matrices as described so far are created at each level of hierarchy i.e. at root level, parent level and child level, as shown in FIG. 6.

Each cluster similar to that in FIG. 5 is broken down into multiple levels of parent-child relationship based on the affinity scores. Child categories have a high overlap with the parent categories. The same sparse matrix is maintained at each level of the hierarchy, thereby creating redundancy. In the system of the present invention, each parent node becomes a classifier for its child node.

To elaborate on the concept mentioned above, the following example may be considered. If the user provides a query term “tablet”, it can be classified as an “electronic item” or “pharmaceutical item”. Based on the transactional data provided and due to the processing by the spend data classification module, a confidence score is generated between the query term and the probable categories obtained on the basis of the final sparse matrix. For instance, if the confidence score for “tablet” for “electronics item” is 70% and “pharmaceutical item” is 30%, the query term will have two probable segments such as—Electronics and Medicines.

Further under each segment, a different confidence score will be generated with respect to each probable family. For instance, under the Electronics segment, confidence score for “tablet” with respect to “SAMSUNG” may be 60% and “APPLE” may be 40%. Similarly, in the Medicines segment, confidence score for “tablet” with respect to “PARACETEMOL” may be 20% and “Amoxicillin” may be 80%. This process is repeated at each level of hierarchy till the commodity level. Based on the respective confidence scores, the system of the present invention is able to identify the most appropriate categories of products and/or services for the query term provided by the user. The score keeps improving with each active learning of the system.

In an embodiment, since the statistical values are taken into consideration in the present system, the categorization rationale works in the following manner. The individual probabilistic values get multiplied to yield a final probabilistic value. Hence, when smaller values are multiplied the final probabilistic values diminish (e.g., 0.4×0.2=0.08), and when the probability is high i.e. 1, the final probabilistic values also remain towards the higher side (eg. 1.0×1.0=1.0). Based on the final probabilistic values, the system of the present invention is able to rank probable categories and prefer one over the other. The output in the form of most probable categories with their confidence score is displayed to the user by means of the communication interface.

In a preferred implementation, the method of the present invention mainly comprises the steps of receiving a dataset of spend data to be classified from a user, transmitting the dataset of spend data to a spend data classification module, processing of the received dataset of spend data by the spend data classification module, and displaying the data processed by the spend data classification module to the user.

The processing of the dataset by the spend data classification module comprises the steps of receiving a dataset of spend data to be classified from a user, transmitting the dataset of spend data to a spend data classification module, processing of the received dataset of spend data by the data classification module, receiving a keyword based query term from the user, mapping the query term to the sparse matrix generated by the sense scorer for classification into appropriate product and/or service categories, and displaying the data processed by the spend data classification module to the user.

During the processing of the dataset of spend data, the sentence tokenizer breaks down the document into individual sentences and passes the data processed by it to the co-reference tagger and the word tokenizer. The co-reference tagger tags the individual sentences based on their association with each other and passes the data processed by it to the sense scorer. The word tokenizer breaks down the individual sentences into individual keywords, tokenizes them and passes the data processed by it to the language dictionary and the taxonomy.

The language dictionary and taxonomy identify the meaning, sense and local context of the individual keywords, and pass the data processed by them to the keyword sense tagger. The keyword sense tagger further extracts and builds sense for each individual keyword based on the data received from the language dictionary and the taxonomy, and passes the data processed by it to the sense scorer. The sense scorer, by means of its three sub-components namely category normalizer matrix, category summarizer matrix and heuristic learning matrix collectively classifies the data processed by the co-reference tagger and keyword sense tagger into appropriate product and/or service categories.

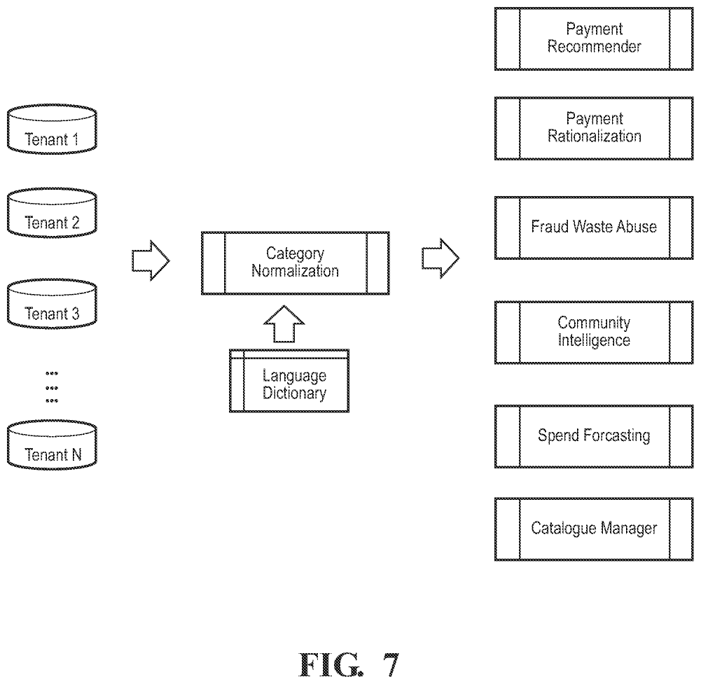

In an alternate implementation, the category normalization aspect of the present invention can also be implemented for catalogue management, spend forecasting, community intelligence, fraud waste abuse, payment rationalization and payment recommendation, as indicated in FIG. 7.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for classification of spend data, comprising:
a user computer system;
a processing unit operably associated with the user computer system;
a communication interface for accessing the user computer system from plurality of input or output devices;
a first input receiving component configured to receive input in the form of a dataset of spend data provided by the user;
a second input receiving component configured to receive input in the form of a query term provided by the user;
a spend data classification module configured to process the dataset in a sequential manner and the query term, to result in classification of the spend data into appropriate product or service categories;
wherein the spend data classification module further comprises of a sentence tokenizer, a word tokenizer, a co-reference tagger, at least one language dictionary, and at least one standard taxonomy or custom taxonomy, a keyword sense tagger, and a sense scorer;
wherein the sense scorer further comprises of a category normalizer matrix, a category summarizer matrix, and a heuristic learning matrix, and generates a sparse matrix capable of actively learning with processing of each document in the dataset, such that the query term is mapped to the sparse matrix for identification of probable product or service categories; and
wherein the system takes local context of keywords in the dataset into consideration, performs classification in an unsupervised manner, has less memory, computation and hardware requirement, has improved accuracy, requires low maintenance, enables user to provide custom taxonomy, works on the principle of heuristic learning, actively learns, adjusts, and develops intelligence, and is capable of classifying the spend data into segment, family, class, and commodity level.

2. The system as claimed in claim 1, wherein the dataset comprises of multiple documents comprising business transactional data of the user.

3. The system as claimed in claim 1, wherein the query term is a keyword based query term, comprising either a single keyword or multiple keywords.

4. The system as claimed in claim 1, wherein the sentence tokenizer breaks down the text contained in the documents of the dataset into multiple individual sentences, preserves the position of these individual sentences in the documents, and passes the data processed by it to the co-reference tagger and the word tokenizer simultaneously.

5. The system as claimed in claim 1, wherein the co-reference tagger tags the individual sentences based on their association in terms of their meaning and context with each other, and passes the data processed by it to the sense scorer.

6. The system as claimed in claim 1, wherein the word tokenizer breaks down individual sentences into individual keywords, tokenizes them and passes the data processed by it to the language dictionary and taxonomy.

7. The system as claimed in claim 1, wherein the language dictionary converted into a Directed Acyclic Graph (DAG) identifies the meaning and synonyms of the individual keywords, and wherein the taxonomy is either a standard taxonomy such as but not limited to UNSPSC, or a custom taxonomy definable by the user.

8. The system as claimed in claim 1, wherein the keyword sense tagger tags individual keywords in respect of their association with each other, and extracts and builds sense for the keywords.

9. The system as claimed in claim 1, wherein the sense scorer computes the affinity score between individual keywords based on the processed data received from the co-reference tagger and the keyword sense tagger, by taking into account the distance between individual keywords and their pairing frequency.

10. The system as claimed in claim 1, wherein the sense scorer further generates a sparse matrix representing clusters of keywords having a high affinity with each other, and expands the vocabulary of the matrix, by way of n-gram expansion and heuristic learning.

11. The system as claimed in claim 10, wherein each cluster is broken down into multiple levels of parent-child relationships based on the affinity scores and wherein the sparse matrix is maintained at each level of the hierarchy such as root, parent and child level such that each node becomes a classifier for its child node.

12. The system as claimed in claim 1, wherein the system is adapted to classify the spend data into segment, family, class and commodity level.

13. A computer implemented method for classification of spend data, comprising the steps of:
receiving a dataset of spend data to be classified from a user;
transmitting the dataset to a spend data classification module;
processing of the dataset by the data classification module, further comprising the steps of:
processing individual documents in the dataset of spend data in a sequential manner, by a sentence tokenizer, a co-reference tagger, a word tokenizer, a language dictionary and a standard or custom taxonomy, a keyword sense tagger, and a sense scorer;
wherein the sentence tokenizer breaks down the document into individual sentences, preserves their location in the documents, and passes the data processed by it to the co-reference tagger and the word tokenizer simultaneously;
wherein the co-reference tagger tags the individual sentences based on their association with each other and passes the data processed by it to the sense scorer;
wherein the word tokenizer breaks down the individual sentences into individual keywords, tokenizes them and passes the data processed by it to the language dictionary and the taxonomy;
wherein the language dictionary which is converted into a Directed Acyclic Graph (DAG) and taxonomy identify the meaning, sense and local context of the individual keywords, and pass the data processed by them to the keyword sense tagger;
wherein the keyword sense tagger extracts and builds sense for each individual keyword based on the data received from the language dictionary and the taxonomy, tags individual keywords in respect of the their association with each other and passes the data processed by it to the sense scorer;
wherein the sense scorer computes the affinity score between individual keywords based on their respective distances and pairing frequency in the dataset, and comprises of three components namely a category normalization matrix, a category summarizer matrix and a heuristic learning matrix, and generates a sparse matrix representing keyword clusters based on the affinity scores;
receiving a keyword based query term from the user;
mapping the query term to the sparse matrix generated by the sense scorer for classification into appropriate product or service categories; and
displaying the data processed in the form of probable categories to the user.

14. The method as claimed in claim 13, wherein the sense of keywords is extracted and build based on language dictionary, taxonomy and probabilistic values of each individual keyword, and by extending it to n-gram fashion to the level of desired configuration.
